(19) United States
(12) Patent Application Publication
(10) Pub. No.: US 2007/0085255 A1
(43) Pub. Date: Apr. 19, 2007

(54) Third hand

(76) Inventor: Willie Joe Doty, Stillwater, OK (US)

Correspondence Address: WILLIE JOE DOTY, 106 W. BURRIS RD., STILLWATER, OK, 74075, US

(21) Appl. No.: 11/507,048

(22) Filed: Mar. 7, 2005

(51) Int. Cl. B25B 1/20

(52) U.S. Cl. 269/41

(57) ABSTRACT

This tool is a new tool in the construction world. It is easy to use and is very functional. It is light weight and can either be made from flat metal, plastic, aluminum or any other alloy.

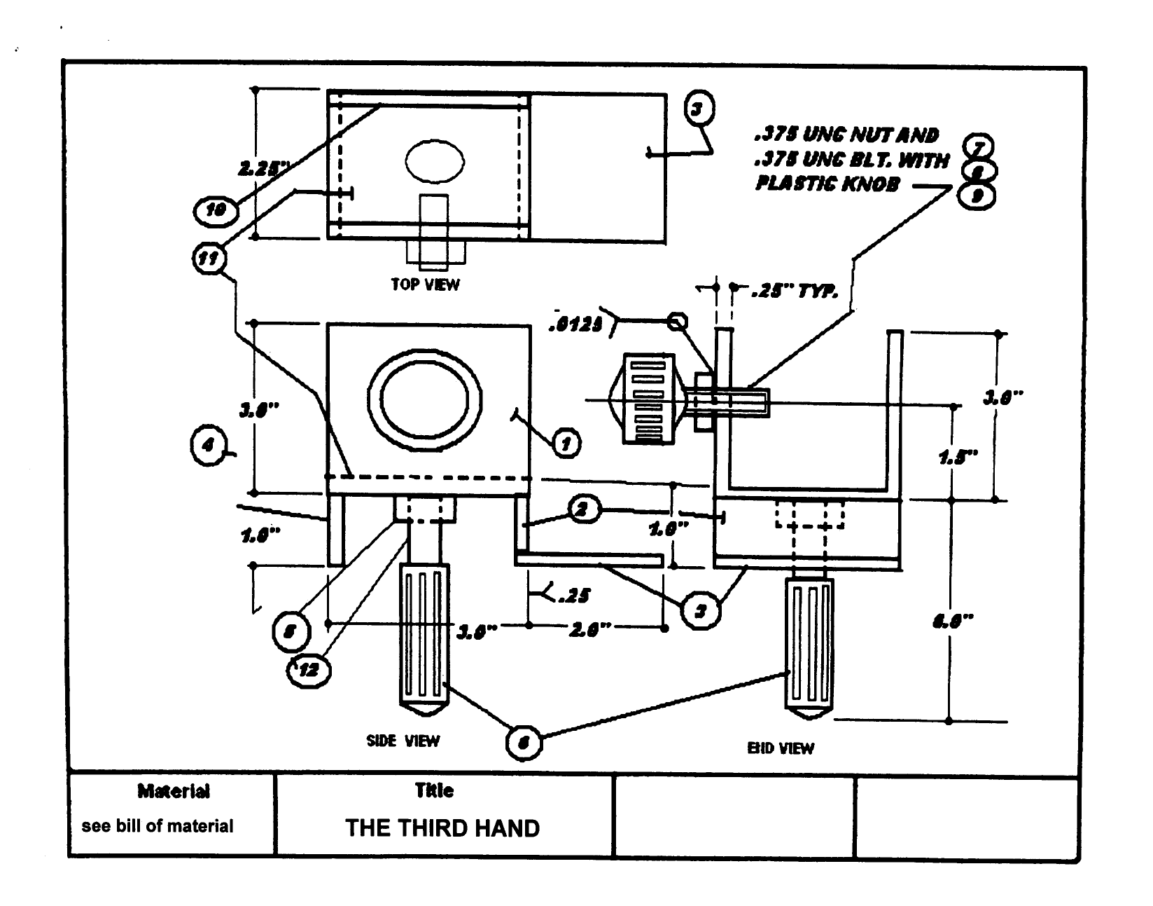

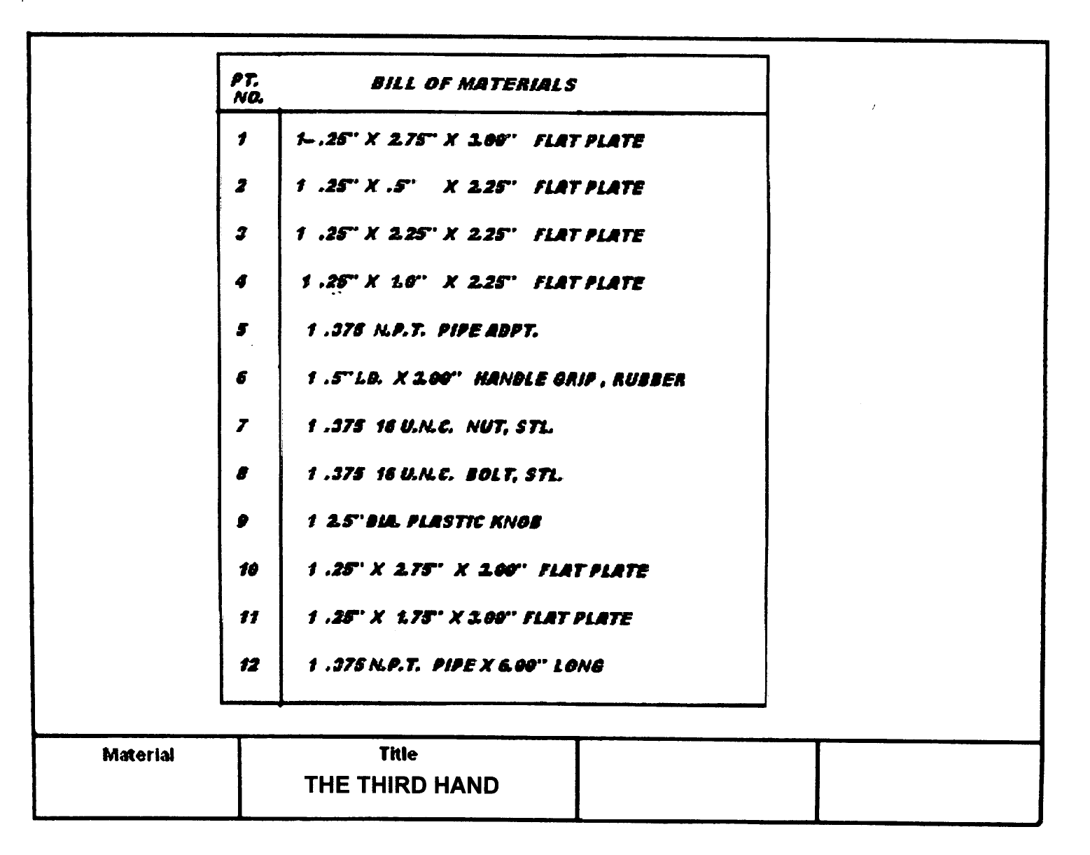

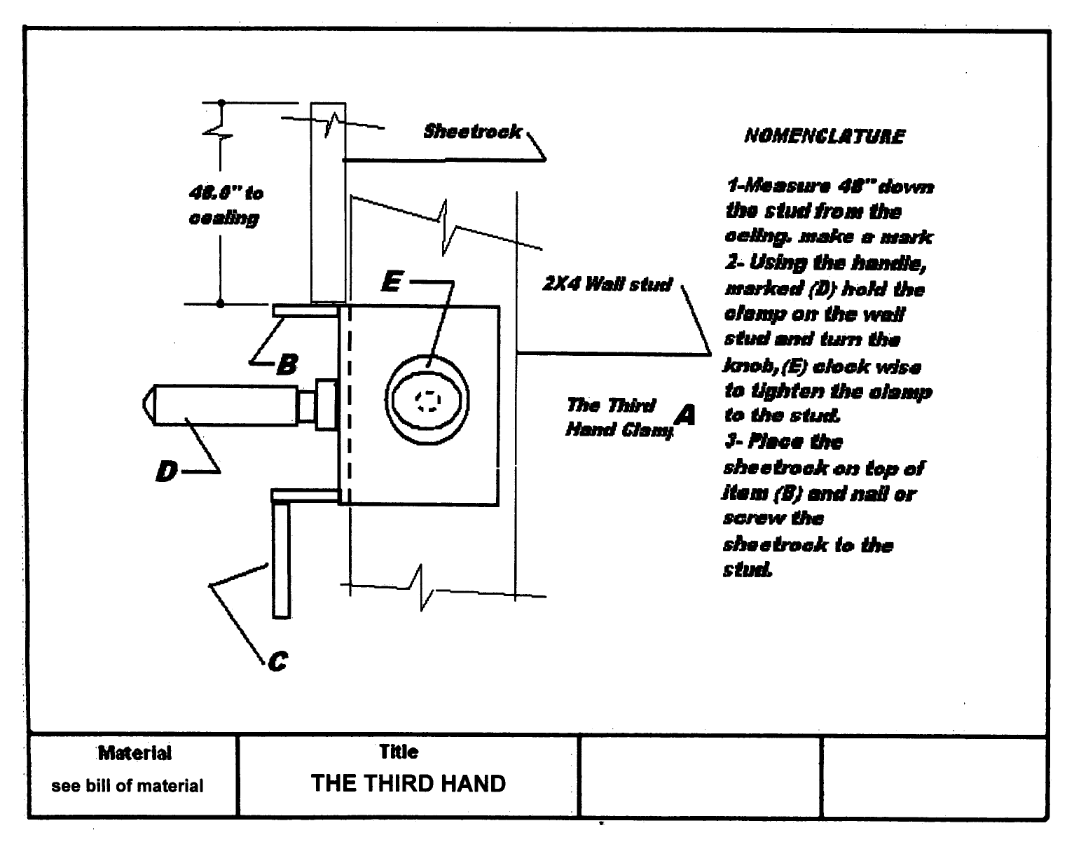

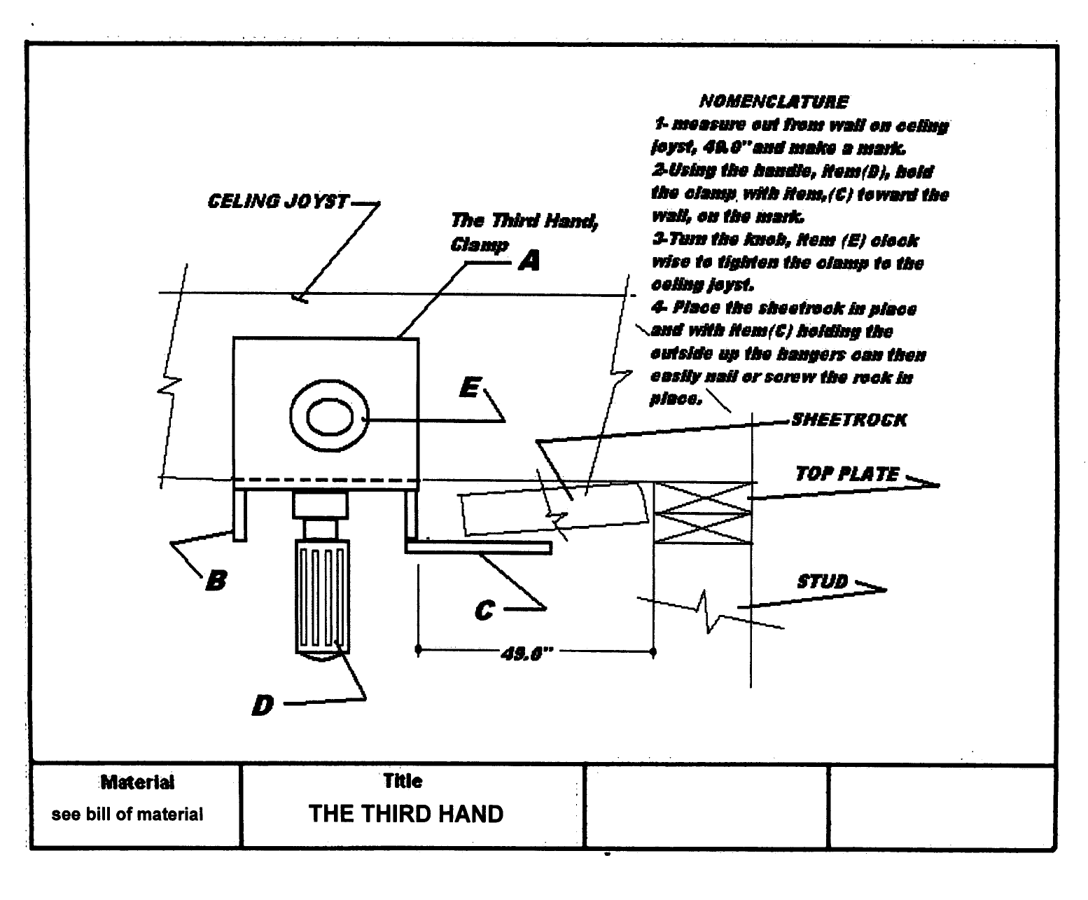

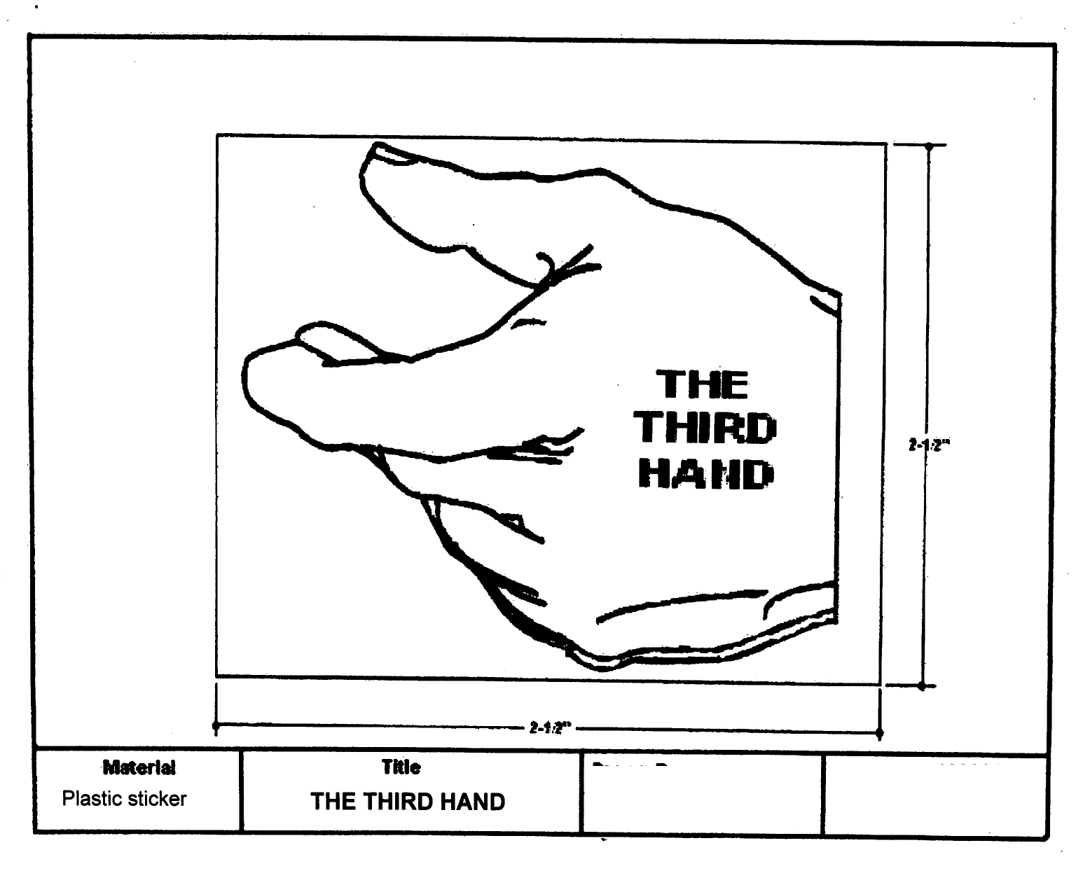

My invention is the product, of my thirty five years in the construction business.

I found that as I got older the sheetrock got heavier.

To help aid me and my crew in hanging sheetrock, I began studying on what I could do to make the job easier.

I made several devices and the tool I am showing you, has been, on several jobs, very usable

In summing up all the features of the Third Hand, I believe, as I feel that you do, that the tool is very unique and usable tool for the sheetrock industry. I know that the tool has been a great help in relieving the stress and weight from the workers as they do their work.

I feel therefore that I should be granted a patent for this new and needed tool.

1. I, W. Joe Doty, claim the design of the tool, called “The Third Hand”. Whether the tool is made from wood, steel, aluminum, plastic or any other alloy.

2. I claim the name of the tool or any similar name.

3. I claim the logo used and any similar logo.

4. I claim the use of the tool or any tool similar to it's usage.
